(19) United States
(12) Patent Application Publication
(10) Pub. No.: US 2017/0051974 A1
(43) Pub. Date: Feb. 23, 2017

(54) INFRARED DRYING SYSTEM FOR WET ORGANIC SOLIDS

(71) Applicants: Christopher P. Moarn, Edina, MN (US); Robert G. Beattie, Brandon, MN (US); Paul D. Rudd, Minneapolis, MN (US)

(72) Inventors: Christopher P. Moarn, Edina, MN (US); Robert G. Beattie, Brandon, MN (US); Paul D. Rudd, Minneapolis, MN (US)

(21) Appl. No.: 15/079,172

(22) Filed: Mar. 24, 2016

Related U.S. Application Data
(63) Continuation of application No. 13/681,082, filed on Nov. 19, 2012, now abandoned.
(60) Provisional application No. 61/561,026, filed on Nov. 17, 2011.

(51) Int. Cl. F26B 3/30; F26B 17/02; F26B 25/22; F26B 3/34

(52) U.S. Cl. CPC F26B 3/30; F26B 3/343; F26B 17/023; F26B 25/22

(57) ABSTRACT

A process for drying wet organic solids to below 10 percent by weight is disclosed wherein an infrared drying system having a housing, a conveyor extending through the housing, at least one infrared heater located within the housing, and a fan for moving an airflow stream through the at least one infrared heater and onto the conveyor. Another step in the process can be providing and feeding wet organic solids onto the conveyor at a metering rate. In one embodiment, the wet organic solids have a moisture content of about 80 percent by weight. Moisture is removed from the wet organic solids by exposing the wet organic solids to at least one infrared heating element within the drying system and an airflow stream that has been heated by the at least one infrared heating element.

### CROSS-REFERENCE TO RELATED APPLICATIONS

This application is a continuation of application Ser. No. 13/681,082, filed Nov. 19, 2012, which claims priority to provisional application Ser. No. 61/561,026, filed Nov. 17, 2011, which applications are incorporated herein by reference in their entirety.

### SUMMARY

This disclosure relates to systems and methods for drying wet organic solids, for example biosolids, through the use of radiant and convective heat generated from at least one infrared heating element. Wet organic solids must be dried in many applications, for example, solids from wastewater treatment systems. In many instances, wet organic solids are dried by convection only. This process is both time consuming and energy intensive. The utilization of radiant heat, especially in combination with convective heat, provides for the possibility of lower operating costs and shortened processing times.

A process for drying wet organic solids is disclosed. One aspect of the process is providing an infrared drying system having a housing, a conveyor extending through the housing, at least one infrared heater located within the housing and being directed towards the conveyor; and a fan for moving an airflow stream through the at least one infrared heater and onto the conveyor. Another step in the process can be providing wet organic solids and feeding the wet organic solids onto the conveyor at a metering rate. In one embodiment, the wet organic solids have a moisture content of about 80 percent by weight or less. Another step in the process can be transporting the waste matter into the housing of the drying system. Moisture is removed from the wet organic solids by exposing the wet organic solids to at least one infrared heating element within the drying system and an airflow stream that has been heated by the at least one infrared heating element. The wet organic solids can remain in the infrared drying system until a moisture content of less than 10 percent by weight is achieved to result in dried solids. Subsequently, the solids can be transported out of the housing, such as by the conveyor.

A process for treating wet organic solids from a wastewater stream is also disclosed wherein an infrared drying system comprising at least one infrared heating element and a heated airflow stream is utilized. In one step, wet organic solids are provided having a moisture content of about 80 percent by weight and a fecal coliform density of between about 1,000 MPN/g TS and about 2×106 MPN/g TS. In other steps a metering rate for feeding the wet organic solids into the treatment system; an exposure intensity output for the waste matter treatment system; and an exposure period for simultaneously exposing the wet organic solids to the heating element and the airflow stream of the treatment system can be determined. The wet organic solids can be fed at the metering rate into the waste treatment system and exposed to the at least one infrared heating element and the heated airflow stream for the exposure period at the exposure intensity output. The metering rate, the exposure intensity output, and the exposure period can be selected to reduce the moisture content of the waste matter to less than 10 percent by weight, and to reduce the fecal coliform density of the waste matter to less than 1,000 MPN/g TS (most probable number per gram of total solids on a dry weight basis).

### BRIEF DESCRIPTION OF THE DRAWINGS

FIG. 1 is a side view of an infrared drying system having features that are examples of aspects in accordance with the principles of the present disclosure.

FIG. 2 is a cross-sectional side view of the infrared drying system shown in FIG. 1.

FIG. 3 is a cross-sectional end view of the infrared drying system shown in FIG. 1.

FIG. 4 is a cross-sectional side view of a multiple line layout including two of the infrared drying systems shown in FIG. 1.

FIG. 5 is a side view of a second embodiment of an infrared drying system having features that are examples of aspects in accordance with the principles of the present disclosure.

FIG. 6 is a cross-sectional side view of the infrared drying system shown in FIG. 5.

FIG. 7 is a cross-sectional end view of the infrared drying system shown in FIG. 5.

FIG. 8 is a cross-sectional side view of a multiple line layout including two of the infrared drying systems shown in FIG. 5.

FIG. 9 is a perspective view of a third embodiment of an infrared drying system having features that are examples of aspects in accordance with the principles of the present disclosure.

FIG. 10 is a side view of the embodiment shown in FIG. 9.

FIG. 11 is a cross-sectional view of the embodiment shown in FIG. 9, taken along section 11-11, as shown in FIG. 10.

FIG. 12 is a cross-sectional view of the embodiment shown in FIG. 9, taken along section 12-12, as shown in FIG. 10.

FIG. 13 is a front end view of the embodiment shown in FIG. 9.

FIG. 14 is a cross-sectional view of the embodiment shown in FIG. 9, taken along section 14-14, as shown in FIG. 13.

FIG. 15 is a rear end view of the embodiment shown in FIG. 9.

FIG. 16 is a cross-sectional view of the embodiment shown in FIG. 9, taken along section 16-16, as shown in FIG. 15.

FIG. 17 is a cross-sectional view of the embodiment shown in FIG. 9, taken along section 16-16, as shown in FIG. 15 with the internal flights modified to have a decreasing pitch length.

FIG. 18 is a cross-sectional view of the embodiment shown in FIG. 9, taken along section 16-16, as shown in FIG. 15 with the internal flights modified to have a decreasing pitch length and a decreasing height.

FIG. 18A is a schematic cross-section of the drum of the dryer shown in FIG. 18 taken near the first end inlet of the drum.

FIG. 18B is a schematic cross-section of the drum of the dryer shown in FIG. 18 taken near the second end outlet of the drum.

FIG. 19 is a schematic of a system having two of the drying systems shown in FIG. 9 in a series arrangement.

FIG. 20 is a schematic of a wastewater treatment system having features that are examples of aspects in accordance with the principles of the present disclosure.

FIG. 21 is a process flow diagram showing the steps in a method for drying solids.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

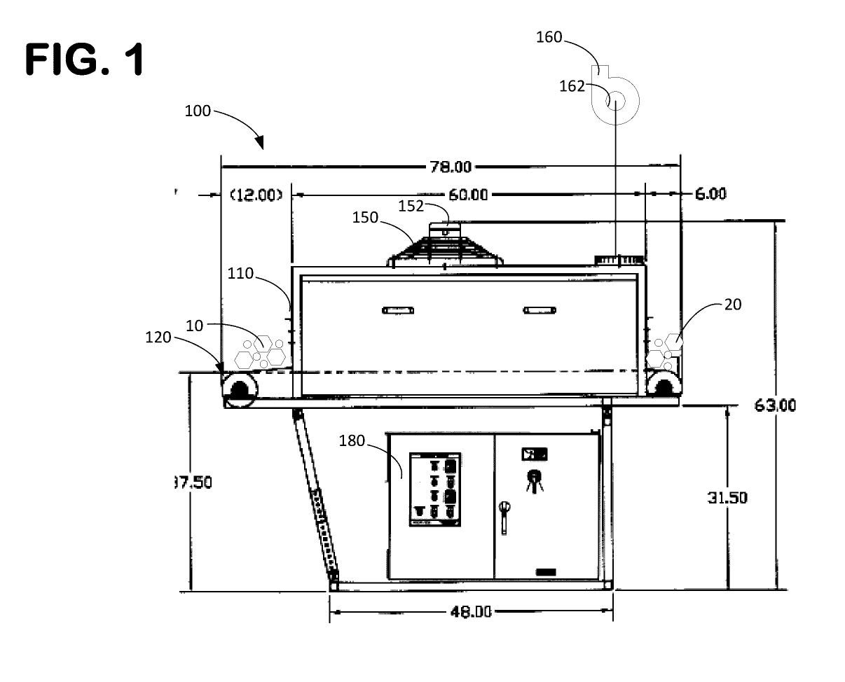

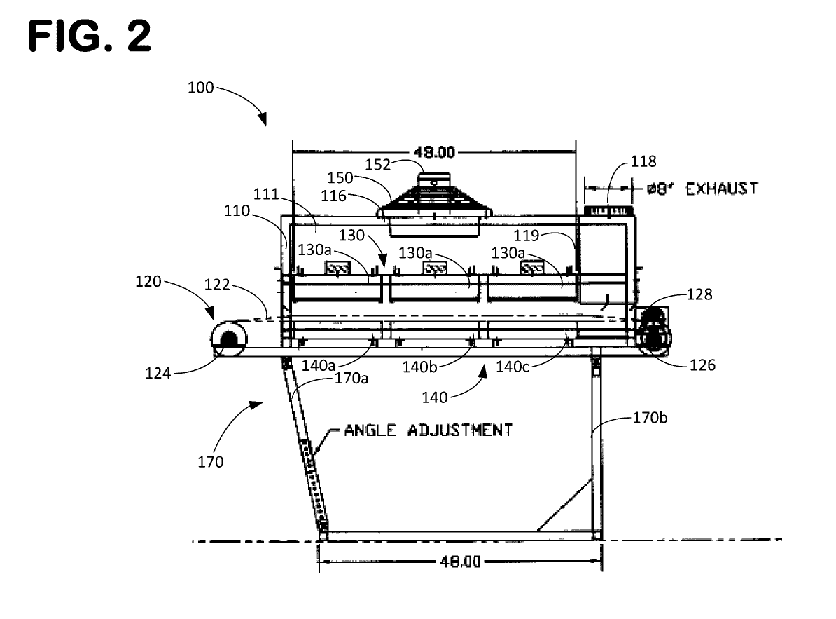

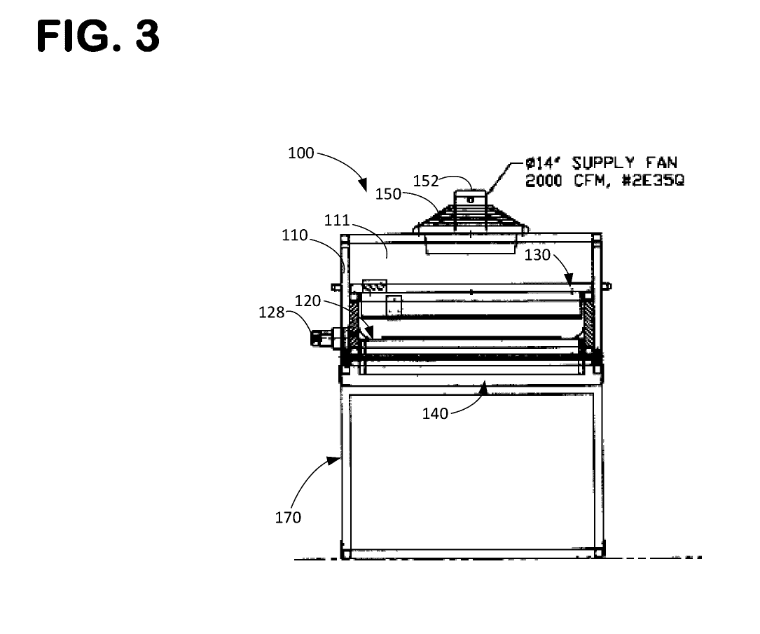

Referring to FIGS. 1-4, an infrared drying system 100 is disclosed. Infrared drying system 100 is for lowering the moisture content of wet solids 10, such as organic solids, to result in dried solids 20. As most easily seen in FIGS. 2-4, infrared drying system 100 is shown as having a housing 110 defining an interior 111. Housing 110 has a process inlet 112 and a process outlet 114. The process inlet 112 is for allowing wet organic solids to enter into the housing interior 111 while process outlet 114 is for allowing dried solids to exit the housing interior 111. In the particular embodiment shown, process inlet 112 and outlet 114 have a width of about 36 inches and a height of about 0.5 inch. In one embodiment, housing 110 is about 60 inches long, about 44 inches wide, and about 24 inches tall. One will appreciate that other dimensions may be selected depending on production requirements.

Housing 110 also includes an air inlet 116 and an air outlet 118. Air inlet 116 is for allowing air to enter the housing 110 while housing air outlet 118 is for allowing air to exhaust from the housing. In the particular embodiment shown, air inlet 116 is located at a top portion of the housing 110 and is about 14 inches in diameter while air outlet 118 is also located at a top portion of the housing 110 and is about 8 inches in diameter. One will appreciate that other dimensions and locations may be selected depending on production requirements.

Extending through the housing 110 is a conveying system 120. Conveying system 120 is for transporting the solids through the housing interior 111 from the process inlet 112 to the process outlet 114. As shown, conveying system 120 includes a conveyor belt 122 extending between two rollers 124, 126. Depending on the characteristics of the wet organic solids, conveyor belt 122 may consist of flat belting, rollers, parallel chains, flatwire, flex wire, or TEFGLAS. In the particular embodiment shown, the conveyer 130 is a flat belt coated with TEFLON. Conveyor belt 122 is also driven by a motor 128. The speed of the motor 128 can be adjusted to vary the speed of the conveyor 120 such that the solids are within the housing interior 111 for a desired period or duration.

Within the housing interior is an upper infrared heating system 130 and a lower infrared heating system 140. Upper infrared heating system 130 is for directly heating the solids to be dried through a combination of radiation and convective heat. Radiant heating is provided by medium or long wave infrared heating elements within heating system 130. Convective heating is provided by the air delivered to the housing interior 111 via air inlet 116 and fan 150, discussed later, as it passes through the heating elements of the upper infrared heating system 130, and onto the solids. Upper infrared heating system 130 can include one infrared heating element or a plurality of infrared heating elements. Furthermore, the heating elements can have either the same or different heating outputs from each other. In the particular embodiment shown, upper infrared heating system 130 includes three heating elements 130a, 130b, 130c that span a majority of the width and length of the housing interior 111. One suitable heating element 130a,b,c suitable for use with the infrared drying system 100 is the Series FSA medium wave infrared radiant heater provided by Process Thermal Dynamics (also known as Pro-Therm) of Brandon, Minn. In the embodiment shown, each heating element 130a, 130b, and 130c has a heating output of about 16,000 watts for a total heating output of about 48,000 watts.

Lower infrared heating system 140 is for providing additional radiant heating to the conveyor belt 122 such that the solids to be dried can be additionally heated by coming into contact with the conveyor belt 122. In the embodiment shown, lower infrared heating system 140 is placed within conveyor belt 122 and directed upwards towards the solids to be dried. Lower infrared heating system 140 can include one infrared heating element or a plurality of infrared heating elements. In the particular embodiment shown, lower infrared heating system 140 includes three heating elements 140a, 140b, 140c that span a majority of the width and length of the housing interior 111. One suitable heating element 140a,b,c suitable for use with the infrared drying system 100 is the Series CB medium wave infrared heater provided by Process Thermal Dynamics of Brandon, Minn. In the embodiment shown, each heating element 130a, 130b, and 130c has a heating output of about 4,000 watts for a total heating output of about 12,000 watts. However, one will understand that different heating outputs can be chosen based on production requirements. Furthermore, the heating elements can have the same or different heating outputs from each other. Additionally, where conveyor belt 122 is not a solid belt, lower infrared heating system 140 can also provide radiant heating to the solids to be dried from below.

Mounted to the air inlet 116 is a fan 150 driven by a motor 152. Fan 150 is for causing air to circulate throughout the housing interior 111 and directly through the upper infrared heating system 130. As stated previously, the air passing through the heating system 130 is heated and provides convective based heating to the wet organic solids. This air circulation also prevents a vapor barrier from forming above the waste products that would otherwise reduce the moisture removal rate from the waste products. In the particular embodiment shown, fan 150 is mounted to the housing 110 at the location of the air inlet 116 such that fan 150 forces air directly into the housing interior 111. Although a small portion of the air will escape through the process inlet and outlet 112, 114, the majority of the air is removed from housing interior 111 via air outlet 118. To ensure that air is forced through the upper infrared heating system 130 and does not bypass directly to air outlet 118, a baffle 119 is provided within the housing interior 111. In one embodiment, fan 150 has a capacity of 2,000 cubic feet per minute. One will appreciate that multiple fans 150 can be utilized simultaneously for a more even distribution of airflow within the housing interior 111. One will also appreciate that fan 150 can be remotely located and connected to the inlet 116 via ductwork. To further facilitate removal of the air from the housing interior via air outlet 118, an exhaust fan 160 driven by a motor 162 can also be provided. In one embodiment, exhaust fan 160 has a capacity of about 2,000 cubic feet per minute.

Infrared drying system 100 is also shown as being supported by a stand 170. Stand 170 can be of any construction suitable to support the weight of housing 110, and the associated components. In the particular embodiment shown, stand 170 is constructed of welded tubular members and has a pair of adjustable legs 170a and a pair of fixed length legs 170b that allow for adjustment of the height and orientation of the housing 110.

To control operation of the infrared drying system 100, a control panel 180 can be provided. Control panel 180 can be configured to monitor and control all of the process variables relating to the drying system. One set of outputs control panel 180 can provide is an on/off/speed control of conveyor motor 128. For example, conveyor motor can be controlled to achieve a belt speed anywhere from 1 inch per minute to 60 inches per minute by control panel 180. Another set of outputs that can be provided is on/off/output level of the upper infrared heating system 130 and lower infrared heating system 140. In one embodiment, output control of the heaters can be provided by an SCR controller. Fans 150 and 160 can also be provided with on/off/speed control. The control panel 180 can also be utilized to measure the conditions of the drying system 100 to provide user or automated feedback for adjusting the process variables. For example, the temperature of the solids to be dried can be sensed and utilized to control the output from the upper infrared heating system 130 and/or the lower infrared heating system 140.

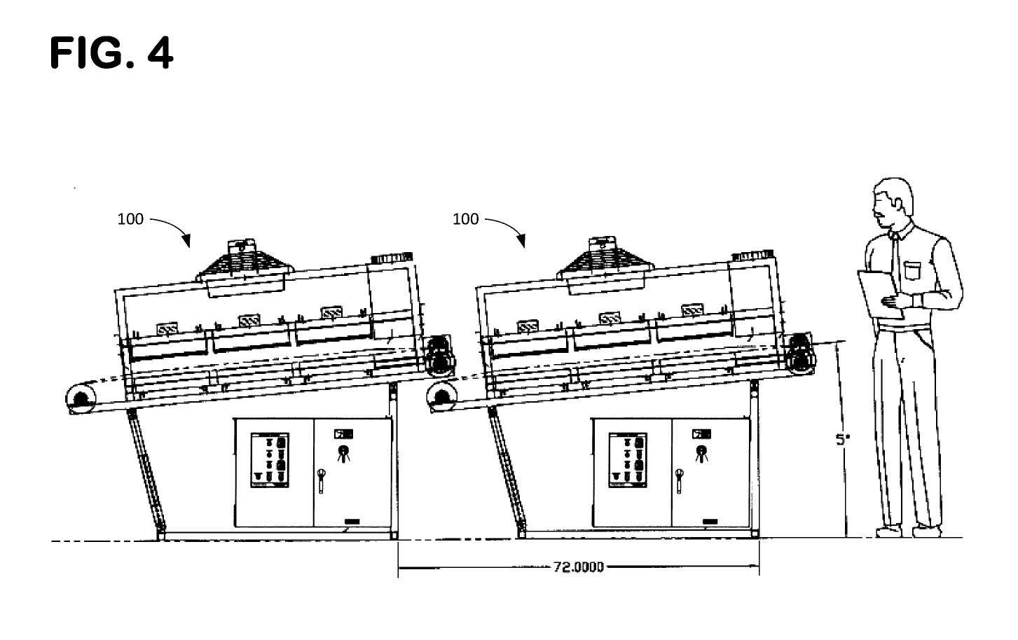

As can be seen most easily in FIG. 4, infrared drying system 100 can be a modular component in a larger system including multiple units. In the particular embodiment, two units 100 are shown and are angled via stand 170. This allows for the solids to be fed onto the conveyor of the downstream unit by the conveyor of the upstream unit. The modularity of infrared drying system 100 allows for increased exposure times for the solids while allowing the system to maintain a higher conveyor belt 122 speed. As a result, an increased metering rate of the wet organic solids can be achieved.

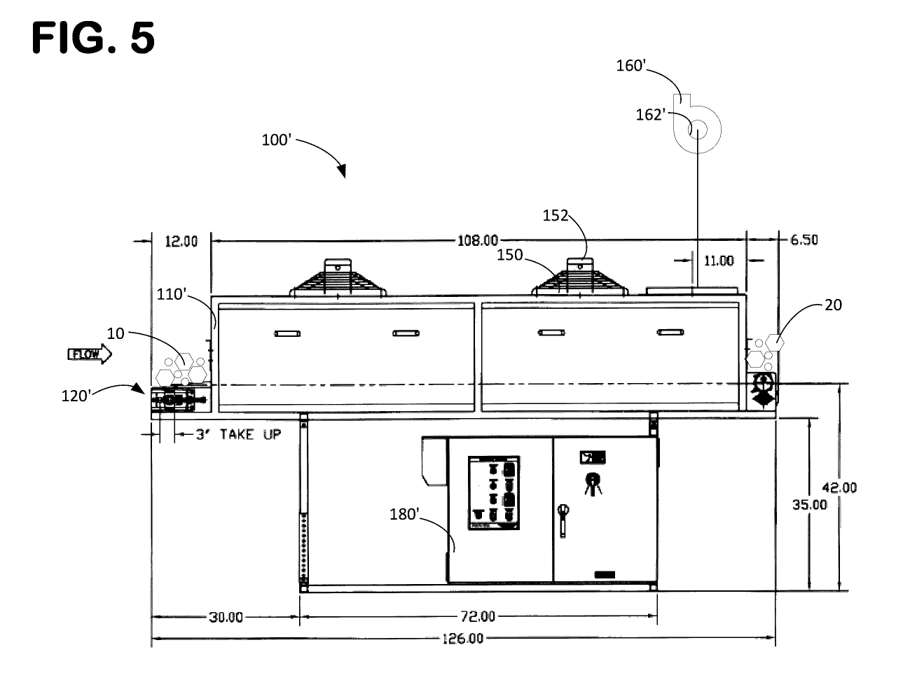

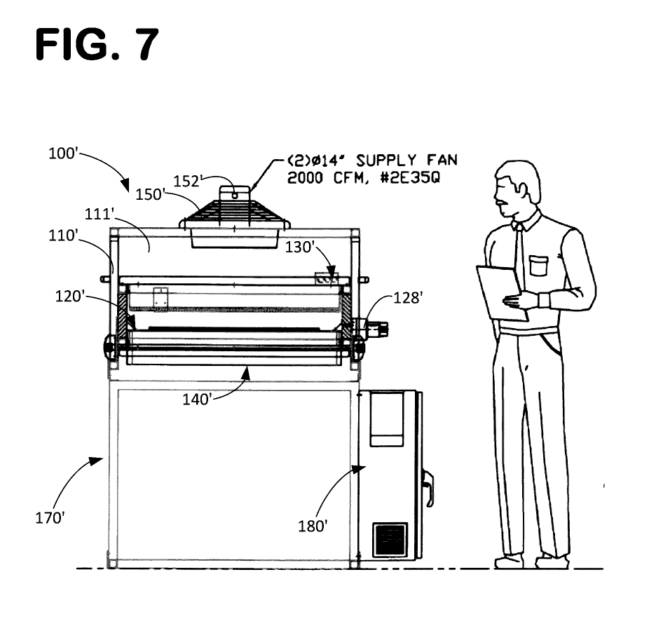

With reference to FIGS. 5-8, a second embodiment of a drying system 100′ is disclosed. The second embodiment is similar to the first embodiment in many aspects. Therefore, the above description of the first embodiment shown in FIGS. 1-4 is applicable to the second embodiment, and is incorporated into the description of the second embodiment by reference in its entirety. Where components are the same or substantially similar, like reference numbers will be used. Differences between the second and first embodiments will be discussed here, the primary differences being that the second embodiment is larger and contains a greater quantity of heating elements and supply fans.

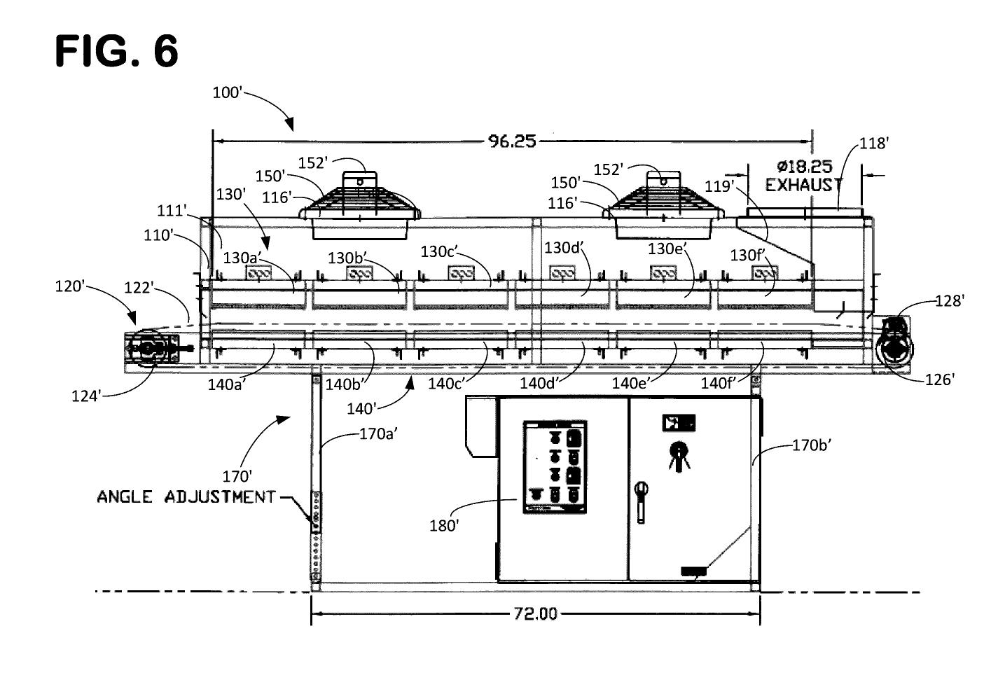

As can be most easily seen in FIG. 6, drying system 100′ has a housing 110′ defining an interior 111′, a process inlet 112′ and a process outlet 114′. In the particular embodiment shown, process inlet 112′ and outlet 114′ have a width of about 36 inches and a height of about 0.5 inch. In one embodiment, housing 110′ is about 108 inches long, about 44 inches wide, and about 24 inches tall. One will appreciate that other dimensions may be selected depending on production requirements.

Housing 110′ also has two air inlets 116′ to which fans 150′ are mounted. In the exemplary embodiment shown, air inlets 116′ are about 14 inches in diameter while fans 150′ have a capacity of about 2,000 cubic feet per minute per fan. Similar to the first embodiment, housing 111′ has a single air outlet 118′ connected to fan 160′ for extracting air from the interior 111′ of the housing. In the particular embodiment shown, air outlet 118′ is about 18.25 inches in diameter and exhaust fan 160′ has a capacity of about 4,000 cubic feet per minute. Due to the increased size of housing 110′, conveyor system 120′ has a longer conveyor belt 122′.

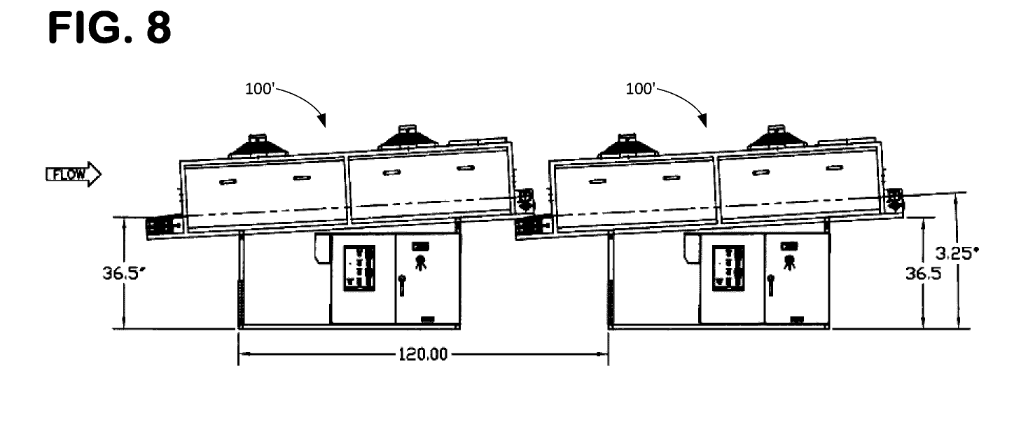

Drying system 100′ is also shown as having an upper infrared heating system 130′ including six individual heating elements 130a to 130f and having a lower infrared heating system 140′ having six individual heating elements 140a to 140f. Due to the increased size of the housing 110′ and the number of heating elements, drying system 100′ has an increased capacity, as compared to drying system 100. Further capacity can be achieved by arranging a plurality of drying systems 100′ end-to-end in a line layout, such as the configuration shown in FIG. 8 where two units 100′ are shown.

From the two embodiments presented in FIGS. 1-8, one skilled in the art will understand that an infrared drying system can be constructed in many different configurations without departing from the concepts presented in this disclosure. For example, the infrared drying system could have a larger or smaller housing; more or fewer supply and exhaust fans having varying capacities; more than two units arranged end-to-end, for example, three to ten units arranged end-to-end; more or fewer upper infrared heating elements of the same or different capacities; more or fewer lower infrared heating elements of the same or different capacities; and manual or fully automated process controls. One skilled in the art will understand from the disclosure that many other variations exist as well.

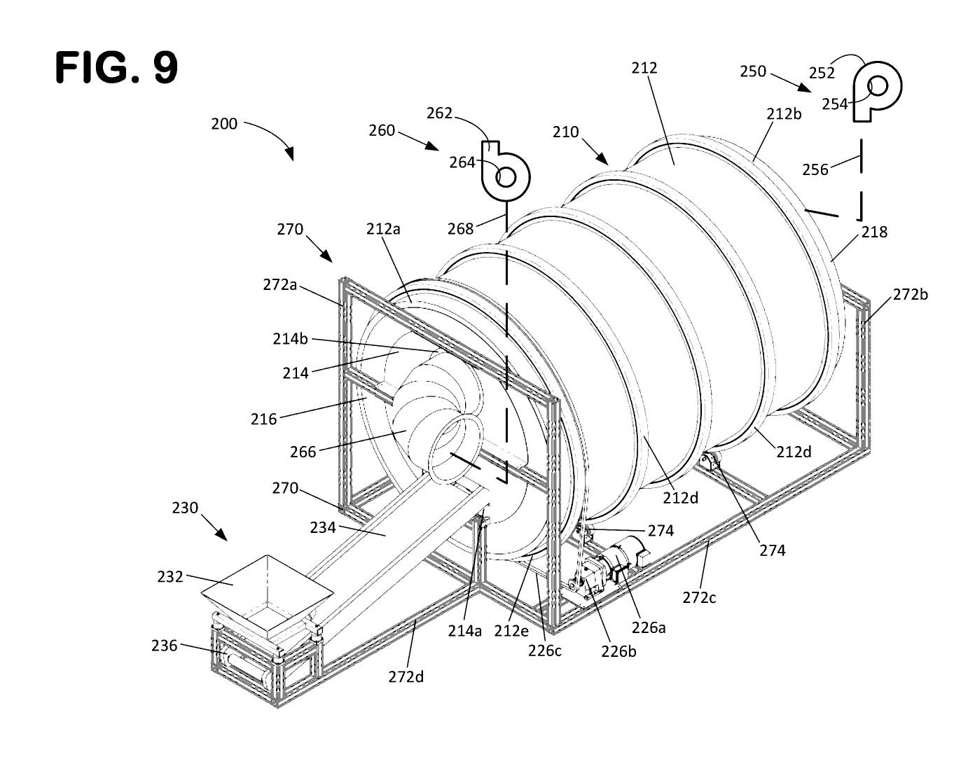

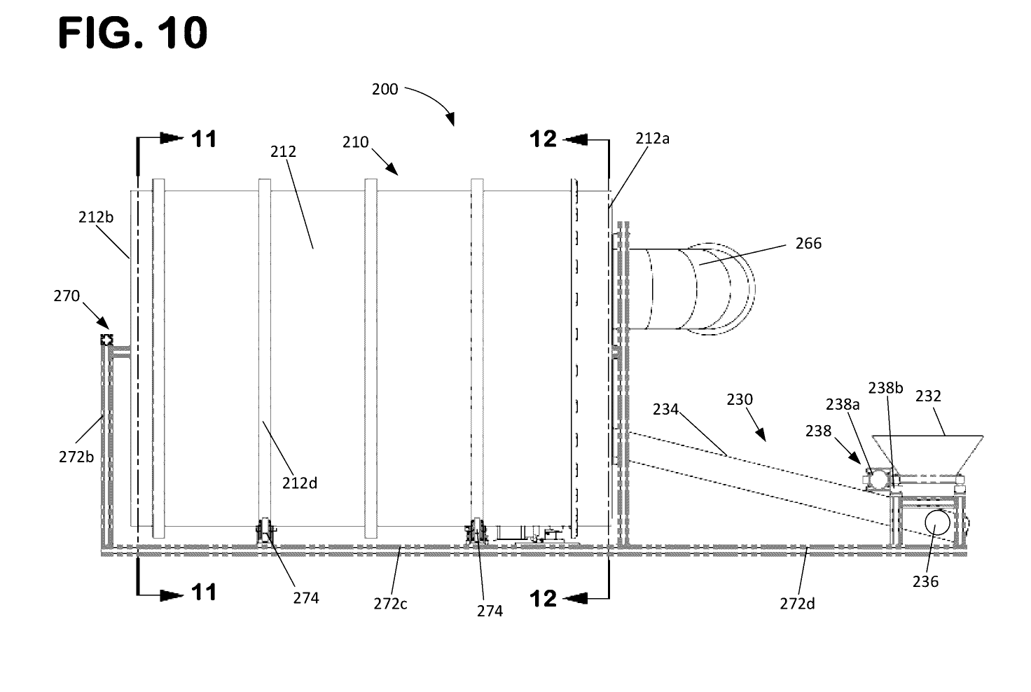

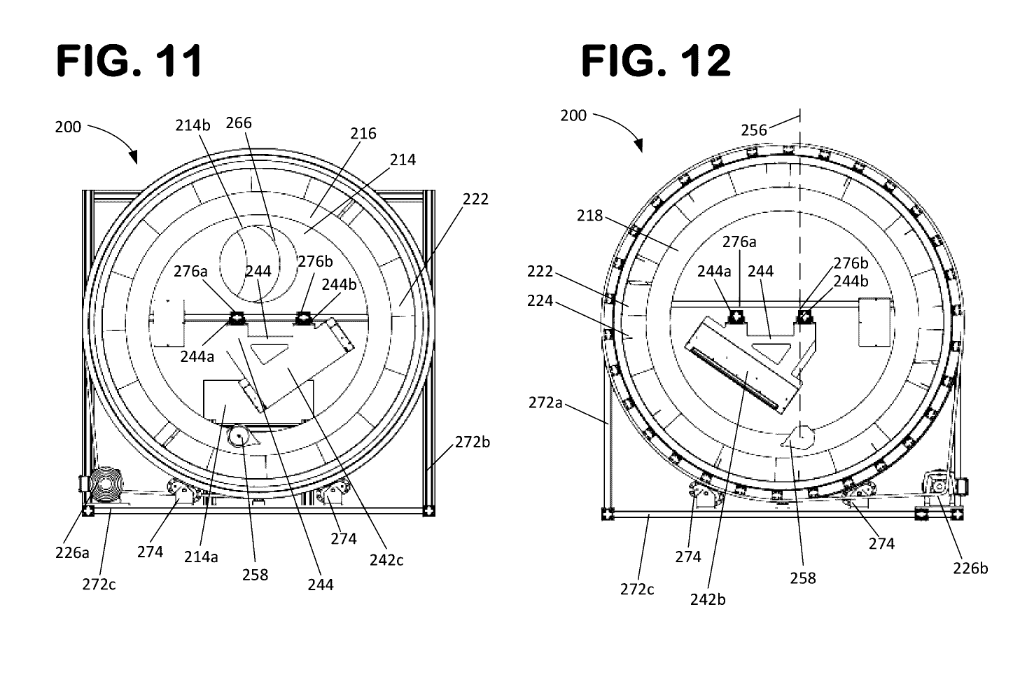

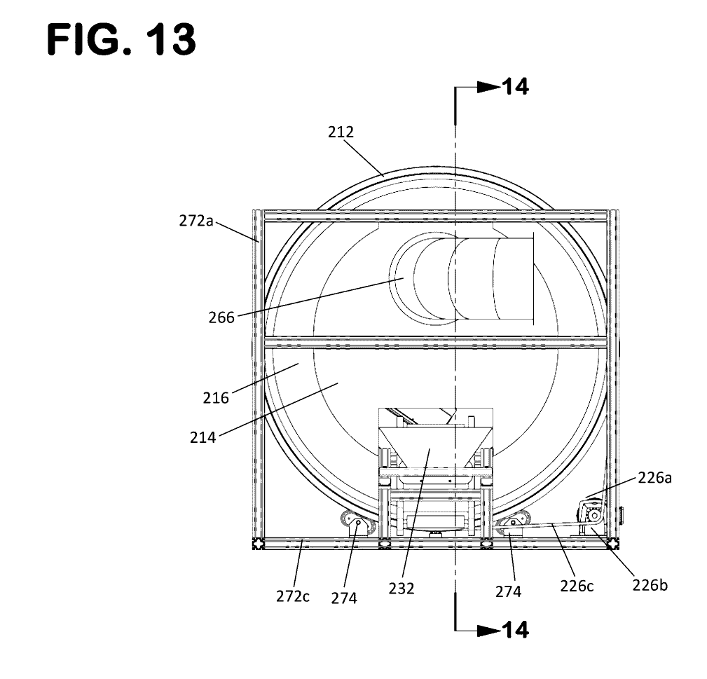

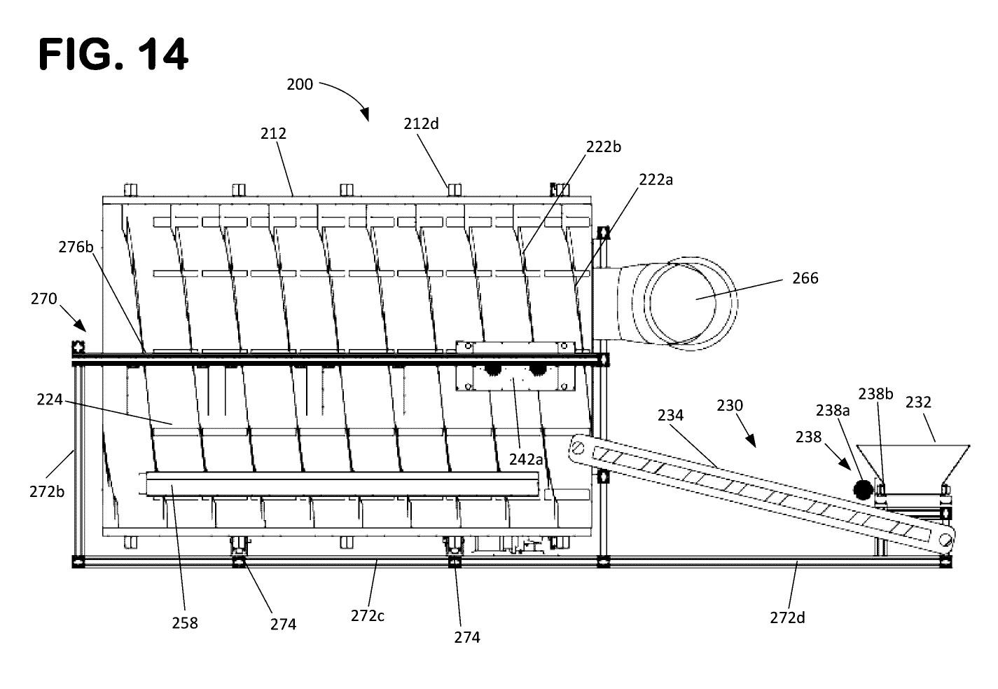

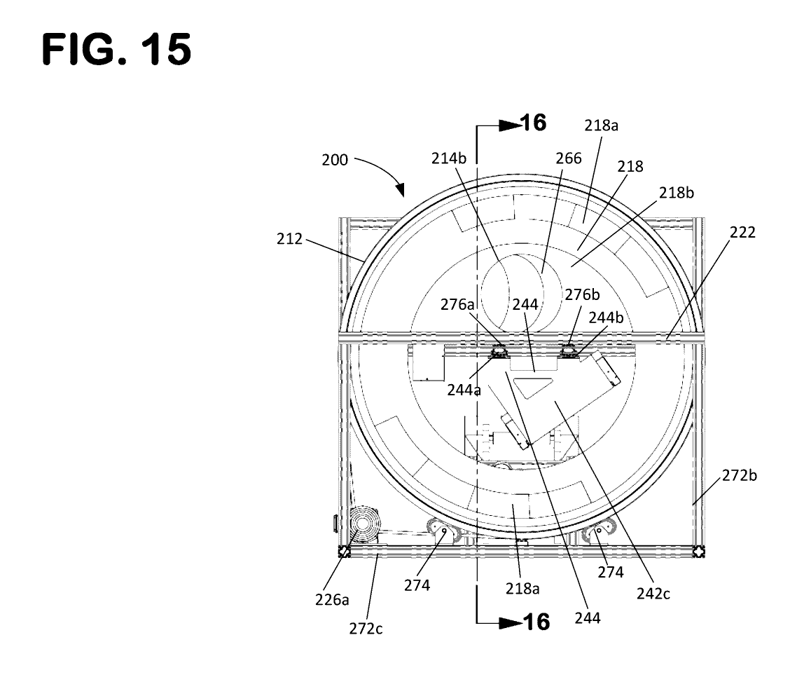

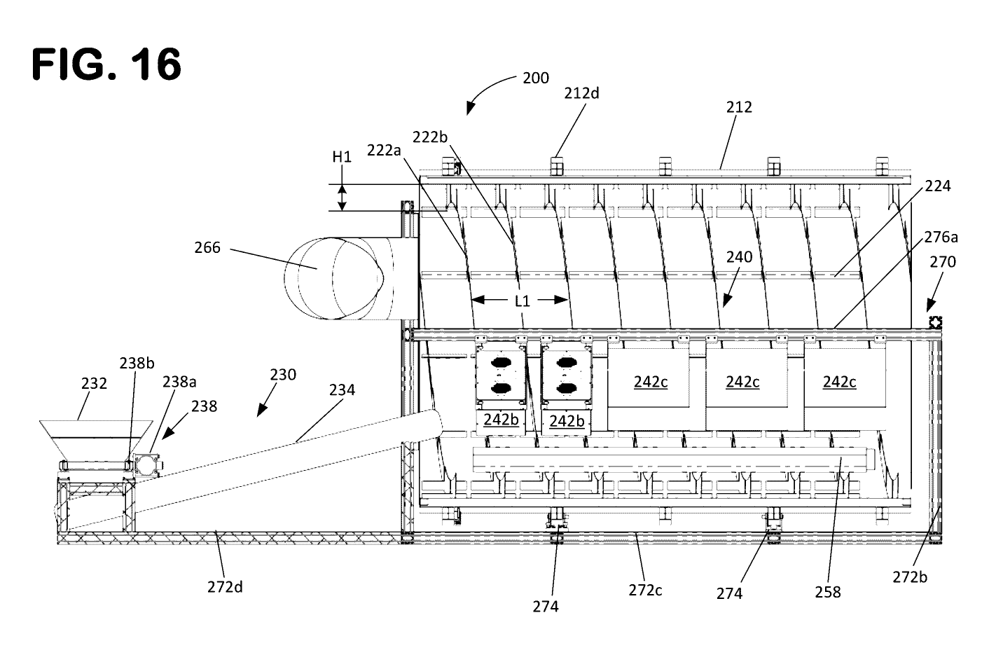

With reference to FIGS. 9-17, a third embodiment of a drying system 200 is disclosed. The third embodiment is similar to the first and second embodiments in some aspects. Therefore, the above description of the embodiments shown in FIGS. 1-8 is applicable to the second embodiment, and is incorporated into the description of the third embodiment by reference in its entirety. Where components are the same or substantially similar, like reference numbers will be used. Differences between the third embodiment and the first and second embodiments will be discussed here, the primary differences being that the second embodiment is larger and contains a greater quantity of heating elements and supply fans.

In the third embodiment, wet solids 10 are processed into dry solids by within a rotating drum drying system 200. As shown, drying system 200 has a housing 210 with a drum 212 extending between a first end 212a and a second end 212b, and defining an interior volume 212c. In one embodiment, the drum housing 210 has a length of about 10 feet and a diameter of about 7 feet.

As shown, the housing 210 is supported by a frame assembly 270. The support frame assembly can have a vertical front section 272a for supporting the first end 212a of the drum 212 and a vertical rear section for supporting the second end 212b of the drum 212. A base portion 272c is provided to support the front and rear sections 272a, 272b. The frame assembly 270 is also provided with a front extension 272d for supporting a conveyor feed system 230, discussed later. The frame assembly 270 also includes an additional frame structure 276 extending between the front and rear sections 272a, 272b and through the interior volume 212c of the drum for slidably supporting an infrared heating system 240, discussed later. As shown, frame structure 276 has a first arm 276a and a second arm 276b, each of which is provided with a channel for receiving the infrared heaters of the heating system 240.

On the exterior of the drum 212 are ribs for providing structural strength to the housing. As shown, two of the ribs 212d are configured to engage with roller assemblies 274 such that the housing 210 is both supported by the roller assemblies 274 and allowed to rotate. As shown, two pairs of roller assemblies 274 are provided to support the drum 212 for a total of four roller assemblies 274. Each of the roller assemblies 274 is shown as being provided with two casters that are pivotally mounted such that the assemblies 274 can easily conform to the outer surface of the drum 212. Other configurations are possible.

Housing 210 is also provided with another rib or channel 212e that is configured to receive a drive belt or chain 226c. As shown, the drive belt or chain 226c wraps around the drum 212 and engages with a gear reducer 226b that is in turn engaged with a drive motor 262a. The gear reducer 226b is selected to allow for the desired rotational rate of the drum 212. Alternatively, motor 262a could be driven by a variable frequency drive and connected directly to the belt or chain 226c without reliance on a gear reducer. When the motor is activated, the drive belt or chain 226b causes the drum to rotate.

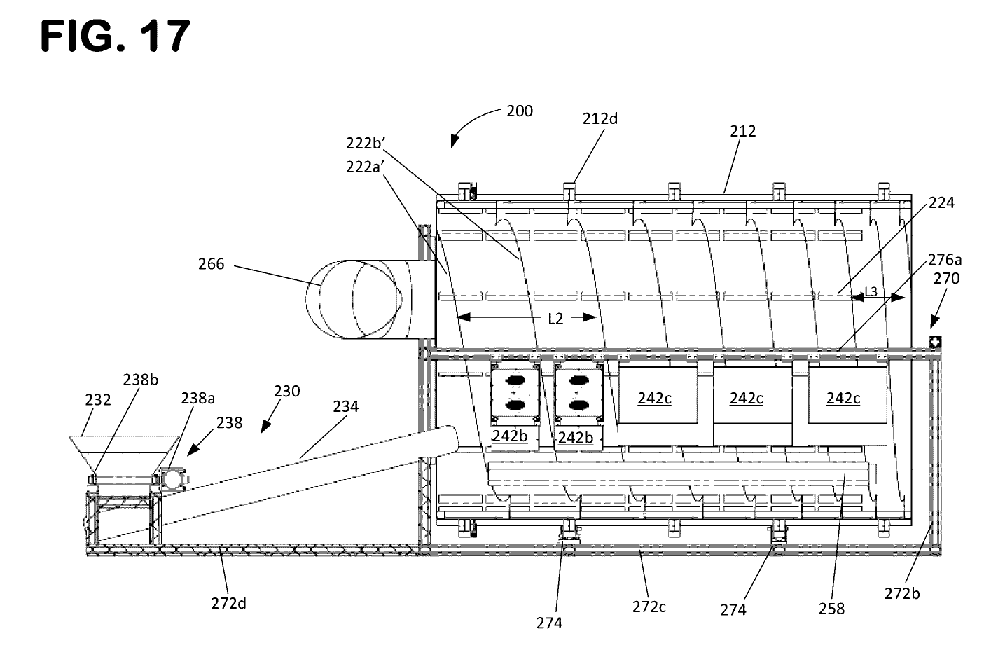

The interior of the housing 210 is provided with a pair of parallel spiral flights 222 (222a, 222b) that move the solids to be dried from the first end 212a to the second end 212b when the drum 212 is rotated. Although two spiral flights 222a, 222b are shown, only one spiral flight 222 could be used, or more than two spiral flights 222 could be used. The spiral flights 222 are arranged on the interior side of the drum 212, and form a pair of continuous helical surfaces from the first end 212a to the second end 212b. As can be most easily seen at FIG. 16, the spiral flights 222a, 222b have a constant height H1 and a constant pitch length L1. The pitch length is the distance between the adjacent blades of each individual flight 222a, 222b at the same radial location along the flight 222a, 222b. Accordingly, the distance between immediately adjacent blades within the drum 212 is one half of the pitch length L1, as the embodiment shown utilizes a two-flight arrangement. In one embodiment, H1 is about 6 inches while length L1 is about 22 inches. Other heights and lengths are possible without departing from the concepts presented herein. Additionally, the height H1 and length L1 can be defined as a function of the diameter and length, respectively, of the drum 212. For example, in the embodiment shown, H1 is about 1/7 the diameter of the drum 212 while L1 is about ⅕ the length of the drum 212.

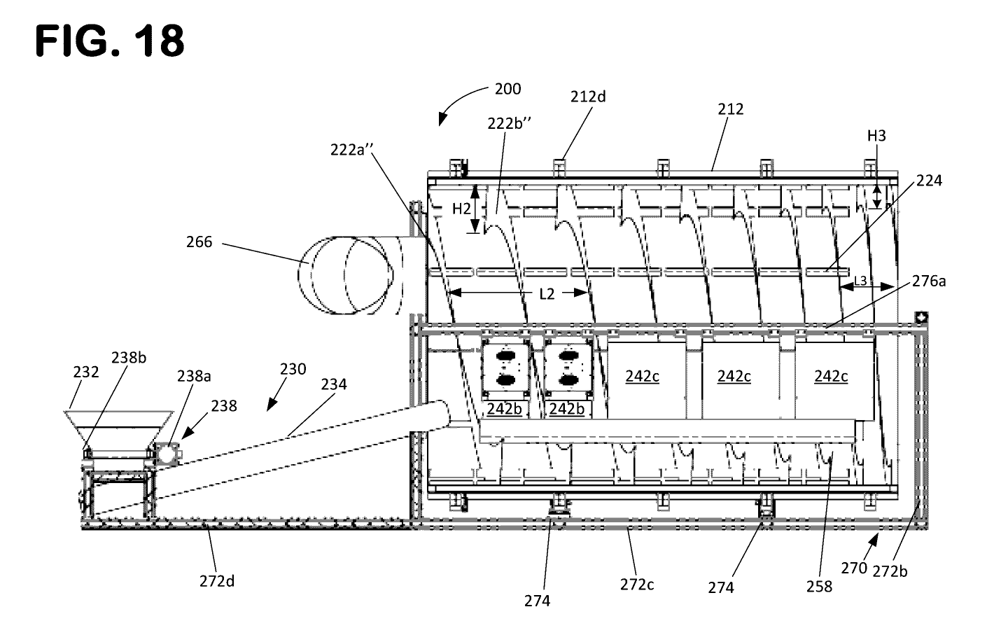

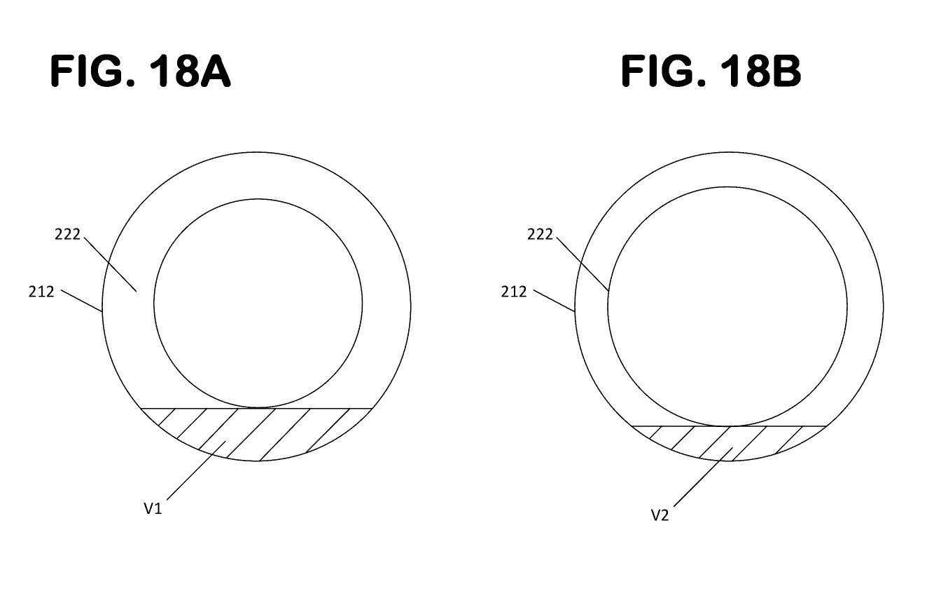

With reference to FIGS. 17 and 18 other flight 222 arrangements are presented. FIG. 17 shows a decreasing flight pitch length and constant flight height arrangement while FIG. 18 shows a decreasing flight pitch and decreasing height arrangement. Wet solids generally decrease in volume as they are being dried due to the removal of water. The degree to which this volume reduction occurs is a function of the physical characteristics of the solids. In one example, dried biosolids 20 can have a volume of about 1/7 of the volume of the starting wet solids 10. In order to maintain a volume of dried solids exiting the drum 212 that is relatively equal to the volume of wet solids entering the drum 212, the flight pitch length and the flight blade height may be decreased along the length of the drum 212 from the first end 212a to the second end 212b. With such an approach, the starting and ending volumes defined by the immediately adjacent flights 222a, 222b and the drum 212 at each end may be defined such that they match the volume reduction of the material being dried.

For example, FIG. 18A schematically shows a first volume V1 defined by the top edge of the flight blade and the bottom of the drum 212 near the first end 212a of the drum 212. The first volume V1 is further defined by the distance between the immediately adjacent blades 222a, 222b (see FIG. 18—one half of L2) which is a function of the pitch length L2 of the flights. FIG. 18B shows a second volume V2 near the second end 212b of the drum 212 of FIG. 18. The second volume V2 is further defined by the distance between the immediately adjacent blades 222a, 222b (see FIG. 18—one half of L3), which is a function of the pitch length L3 of the flights. As such, the first and second volumes V1, V2 can be a function of the anticipated reduction in volume of the solids to be dried. For example, in one embodiment, the second volume V2 is configured to be about 1/7^{th} of the first volume V1, and thereby accommodates a constant volumetric flow of solids through the drum 212 in an application where the solids volume decreases by about 1/7^{th} during drying.

In the embodiment shown at FIGS. 17 and 18, the spiral flights have an initial pitch length L2 of about 40 inches and an ending pitch length L3 of about 12 inches resulting in pitch length ratio L3/L2 of about ⅓. Other variable pitch arrangements are also possible without departing from the concepts presented herein. In the embodiment shown at FIG. 18, the flight height is also shown as decreasing between a height H2 and a height H3. Where the volume of the material is reduced as it is moved towards the back end of the drum 212, the material depth can correspondingly decrease. As such, the height of the flights 222 can also be decreased, at least to the extent that the decreasing pitch length does not maintain the height of the solids within the drum 212. As noted above, it should be appreciated that the pitch length reduction and the height reduction of the flights can be coordinated together to obtain the desired flow characteristics for the solids being dried within the drum 212. Furthermore, it is noted that the pitch length reduction and the flight blade height reduction can be a function of the physical properties of the solids to be dried, for example, the expected volume reduction of the solids to be dried. Stated another way, the first volume V1 and the second volume V2 can be a function of the physical properties of the solids to be dried, for example, the expected volume reduction of the solids to be dried.

The interior of the drum 212, between the blades of the spiral flights 222a, 222b, is provided with a plurality of cleats 224 radially spaced about the interior surface. The cleats 224 act to lift the solids residing at the bottom of the interior volume of the drum housing 210 towards the top layer of solids. In one embodiment, the cleats 224 have a height that is less than or equal to the height of the spiral flights 222. In one embodiment, the cleats are about 3 inches tall. The churning action caused by the cleats 224 assures that the solids within the drum are exposed in a more even fashion to the infrared heating system 240, discussed later.

As shown, the housing 210 at the first end 212a is also provided with a front end plate 216 and a center plate 214 located within the front end plate 216. As configured, the front end plate 216 has a height of about 15 inches and is fixed to the drum 212 while the center plate 214 is fixed to the front section 272a of the support assembly 270. Accordingly, front end plate 216 rotates with drum 212 while center plate 214 does not. In the embodiment shown, a gap, for example about a ¼ inch gap, is provided between the plates 214, 216 such that no frictional resistance is caused by the drum rotation. Alternatively, a low friction bearing surface could be provided to eliminate the gap. As shown, the center plate 214 is provided with a first opening 214a for allowing the wet solids 10 to be introduced into the interior volume 212c of the drum 212. In the embodiment shown, opening 214a is configured to receive the discharge end of a belt type conveyor 234. The center plate 214 is also shown as having a second opening 214b which is configured to receive an exhaust outlet duct 266. Exhaust outlet duct 266 is for allowing relatively moist air travelling through the drum interior volume 212c to be exhausted to the outdoors.

The housing 210 at the second end 212b is provided with a back end plate 218. As shown, the back end plate 218 is provided with a large central opening 218b that allows for air to easily enter the interior volume 212c of the drum 212 such that it can absorb moisture within the drum 212 and be exhausted via outlet duct 266. The back end plate is also provided with two curved openings 218b for allowing the dried solids 20 to exit the drum 212. As shown, the number of openings 218b corresponds with the number of spiral flights 222 such that each opening 218b is aligned with one of the spiral flights 222.

As shown, the heating system 240 includes a plurality of electric infrared heaters 242 for drying the solids 10. Although the infrared heaters 242 are shown as being electric, the heaters 242 may also be configured as gas or liquid propane infrared heaters. Additionally, the heaters 242 may be configured to have different heating outputs from each other. In the embodiment shown, a first infrared heater 242a is provided near the first end 212a where the wet solids 10 are first introduced. As shown, first infrared heater 242a is configured as a short wave electric infrared heater and operates to preheat the drum 212 such that conductive heat can be transferred from the drum 212 to the wet solids 10 residing at the bottom of the drum 212. In the configuration presented, the first infrared heater 242a is slidably mounted to the frame structure 276 and is oriented horizontally to face directly downwards towards the bottom of the drum 212.

Also shown is a pair of second infrared heaters 242b that are configured as electric short wavelength heaters. The second heaters 242b operate to transfer infrared energy to the wet solids 10 after entrance at the front end 212a. Short wavelength heaters are capable of dissipating a high heat flux density and therefore are beneficial for use in drying the wet solids 10 at their most moisture laden stage. Adjacent to the second infrared heaters 242b is a set of three third infrared heaters 242c. The third infrared heaters 242c are configured as electric medium wavelength heaters and operate to further reduce the moisture content of the wet solids. As configured, the second and third heaters 242b, 242c are oriented at an angle with respect to the drum 212. In the embodiment shown, the heaters 242b, 242c are oriented at about a 55 degree angle with respect to the vertical plane extending through the longitudinal axis of the drum 212. It is also noted that the heaters 242b, 242c are oriented to face the side of the drum 212 at which the cleats 224 bring up the wet solids 10 from the bottom of the drum 212 such that infrared heat is applied to the solids as they are being continually deposited at the top surface. However, other orientations are possible, such as a completely horizontal configuration similar to that shown for the first heater 242a.

The heaters 242b, 242c are supported by a bracketing system 244 that attaches to the support structure 276 at the first arm 276a and 276b. As shown, bracketing system 244 has a first arm 244a that engages into the channel of the support structure first arm 276a and a second arm 244b that engages into the channel of the support structure second arm 276b. The heater 242a is provided with a similar configuration, but with a bracket that does not hold the heater at an angle. As configured, the first and second arms 244a, 244b are received by and slide within the channels of the first and second arms 276a, 276b. Accordingly, the bracket and channel configuration allows for each of the heaters 242 to be slidably removable from the interior volume 212c without requiring service personnel to enter into the drum. In one embodiment, the channels and/or arms are coated with an HDPE material to reduce friction. It is noted that this configuration allows for the heater configuration to be changed from one application to another more easily. In one embodiment, a chain drive system (not shown) can be provided to pull the heaters 242 into and out of the drum 212. It is noted that the bracket could be alternatively configured with the channel and that the support arms 276a, 276b could be configured to be received within the bracket channels. It is further noted that each of the heaters can be configured with gas or electric connectors that allow for the heaters to be connected and disconnected to each other as they are installed and removed, respectively.

As shown, drying system also includes a conveying system 230 for delivering wet solids 10 to the drum 212. As shown, conveying system 230 includes an inlet hopper 232 and a conveyor 234. As configured, inlet hopper 232 receives the wet solids 10 and deposits the wet solids 10 onto the conveyor 234 which in turn transports the solids into the interior volume 212c of the drum 212. As shown, the inlet hopper 232 is provided with a mesh screen (not shown) and a vibrator assembly 238, wherein the hopper 232 is mounted on vibration isolators 238b and wherein a motor assembly 238a with eccentric weights is mounted to the hopper. The motor assembly 238b may include a variable frequency drive. When the motor assembly 238b operates, the hopper 232 is vibrated and sifts the solids through the mesh screen without imparting vibration onto the conveyor 234. As shown, the conveyor 234 is a belt type conveyor with an electric motor drive system 236. However, other types of conveyors may be used, for example an auger type conveyor.

The drying system 200 can also provided with a supply air system 250. As shown, the supply air system includes a supply fan 252 having a motor 254 that is in airflow communication with an air knife 258 via ducting 256. As configured, the air knife 258 discharges high velocity air along its length directly at the surface of the wet solids 10 on the same side of the drum 212 as the heaters 242b, 242c where the cleats 242 are churning the solids 10 upwards. In one embodiment, the air knife discharges air at about 1,000 to 2,000 feet per minute. In one embodiment, the air knife discharges air through spaced openings along its length while in another embodiment the air knife discharges air through a continuous opening along its length. In operation, the air knife 258 disturbs the moisture laden air immediately adjacent to the wet solids 10 with relatively drier air and therefore operates to reduce the vapor pressure of the adjacent air which increases the capacity of the infrared heaters 242b, 242c to remove moisture from the wet solids 10. Although one air knife 258 is shown extending a majority of the length of the drum 212, more air knives 258 may be used without departing from the concepts presented herein. The supply air system may also be provided with a heater (not shown) to increase the temperature of the air entering the drum 212. The heater may be installed in the ducting 256.

The drying system 200 is also provided with an exhaust system 260 that connects to the drum outlet 266. As shown, the exhaust system 260 includes a fan 262 having a motor 264 and being in air flow communication with the drum outlet 266 via ducting 268. In one embodiment, the exhaust fan removes about 4,000 cubic feet per minute of air from the drum 212, and the ducting 268 and drum outlet 266 have a diameter of about 20 inches.

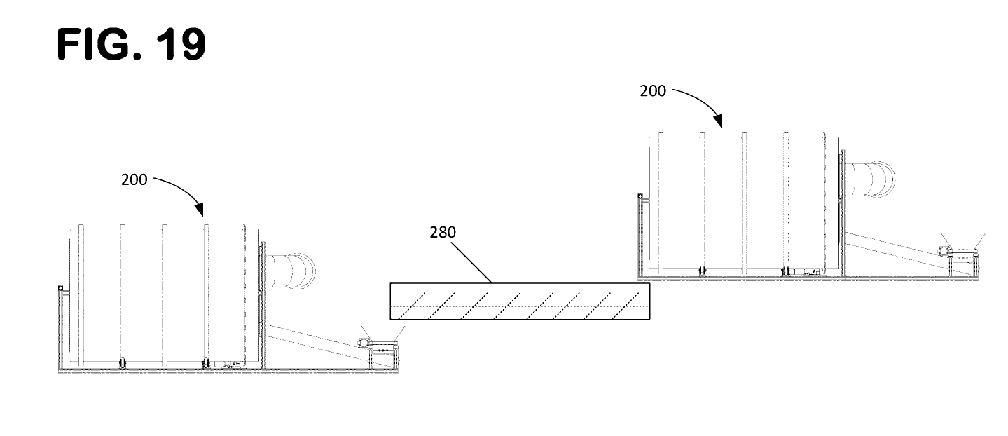

Multiple drying systems 200 may be arranged in series in order to obtain a desired moisture content for the dried solids 20. For example, FIG. 19 shows two drying systems 200 arranged in a series arrangement with a conveying system 280 extending from the discharge openings of the first drying system to the inlet hopper of the second drying system. As shown, the conveying system is an auger type conveyor, but other types of conveying systems may be utilized, such as belt type conveyors. One skilled in the art will understand that the concept shown at FIG. 19 can be expanded to include any number of in-series drying systems 200, such as 3, 4, 5, or more drying systems 200 in a series arrangement. It is also noted that the downstream dryers 200 may be of a smaller size as compared to the upstream dryers 200 which is particularly beneficial in cases where the volume of the solids is significantly reduced during the drying process. It is also noted that the hopper assembly may or may not be used on the downstream drying systems 200, as desired. Where the hopper assembly is not provided the conveyor 280 can be configured to deposit solids directly onto conveyor 234 or directly into the drum 212.

In the embodiment shown, drying system 200 has infrared heaters 242 configured to provide about 924,000 btu/hr, wherein the first heater 242a has an output of about 30 kw, the second heaters 242b have an output of about 13 kW each, and the third heaters 242c have an output of about 39 kW each. Also, the drum 212 is configured to be rotated at about 9 revolutions every 20 minutes, or at about 0.45 rpm. The flights 222 within the drum 212 are configured such that about 11 cubic feet of solids can be continually processed through one pass of the drum 212 which takes about 20 minutes at the aforementioned rotational rate. In one embodiment, drying system 200 can be configured to dry solids having about 80% water by weight to a moisture content of about 10% by weight in a single pass through the drum 212 for a total processing volumetric rate of 33 cubic feet of wet solids per hour. In order to meet EPA standards for drying wet solids, the flight pitch, the flight pitch length reduction, and/or the drum rotation rate can be adjusted such that the reside time is sufficiently long in relation to the required temperature of the solids being dried. For example, the flight pitch, the flight pitch length reduction, and/or the drum rotation rate can be adjusted to result in a reside time of 30 minutes or longer.

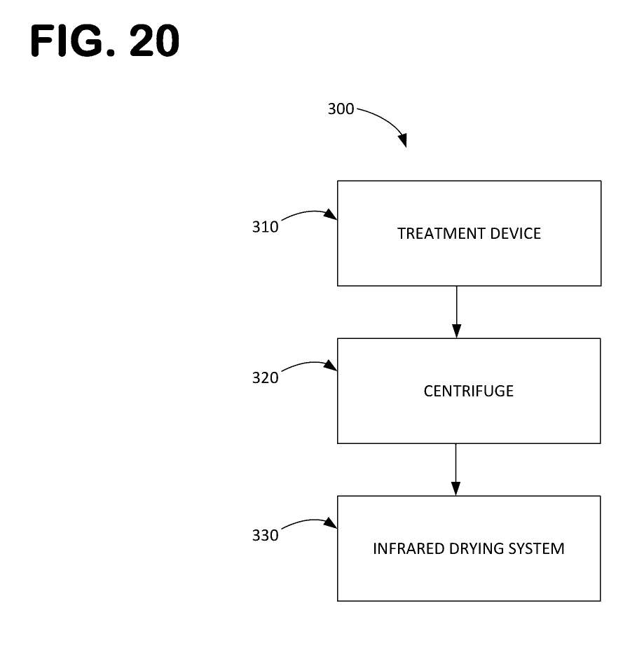

With reference to FIG. 20, the disclosed infrared drying systems can also be utilized as a component in a wastewater treatment system 300 designed to remove pathogens and separate solids from liquids. As shown, wastewater treatment system 300 includes a primary treatment system 310. In one embodiment treatment system 310 includes at least an aerobic and/or anaerobic digester for decomposing the biological content. System 310 may also include an initial separation stage, for example a clarifier.

Wastewater treatment system 300 is also shown as including a centrifuge system 320. Centrifuge system 320 may be used instead of or in addition to system 310. Centrifuge system 320 is for providing a separation of water from the solids and can be configured to increase the solids content of the waste stream to about 20% by weight to provide wet organic solids. One centrifuge system 320 suitable for use in system 300 is the CS-10 Centrifuge manufactured by Centrisys Centrifuge of Kenosha, Wis. Other systems known in the art may also be used for system 320, provided they perform the same separation function of centrifuge system 320.

Wastewater treatment system 200 also includes an infrared drying system 330, to which the wet organic solids provided by the centrifuge system are delivered. Either of infrared drying systems 100, 100′, or 200 and variations thereof, may be used as system 330. As such all previous descriptions of systems 100, 100′, and 200 are incorporated by reference in their entirety into the description of system 330. In the embodiment shown, system 330 is configured in an end-to-end arrangement similar to that shown in FIG. 4, and can process about 10 tons per hour of wet organic solids. In operation the wet organic solids can be dried by exposing them to the heating systems for a total exposure period of about 12 minutes (about seven minutes per dryer). In one embodiment, each dryer in system 230 includes an upper infrared heating system configured to provide about 26,100 watts of heat and a lower infrared heating system configured to provide about 5,800 watts of heat with a total system connected electrical load of 65.22 kW. As configured, system 330 can further reduce the moisture content of the wet organic solids to 10% by weight or lower, and can kill up to 99% of the pathogens present in the wet organic solids.

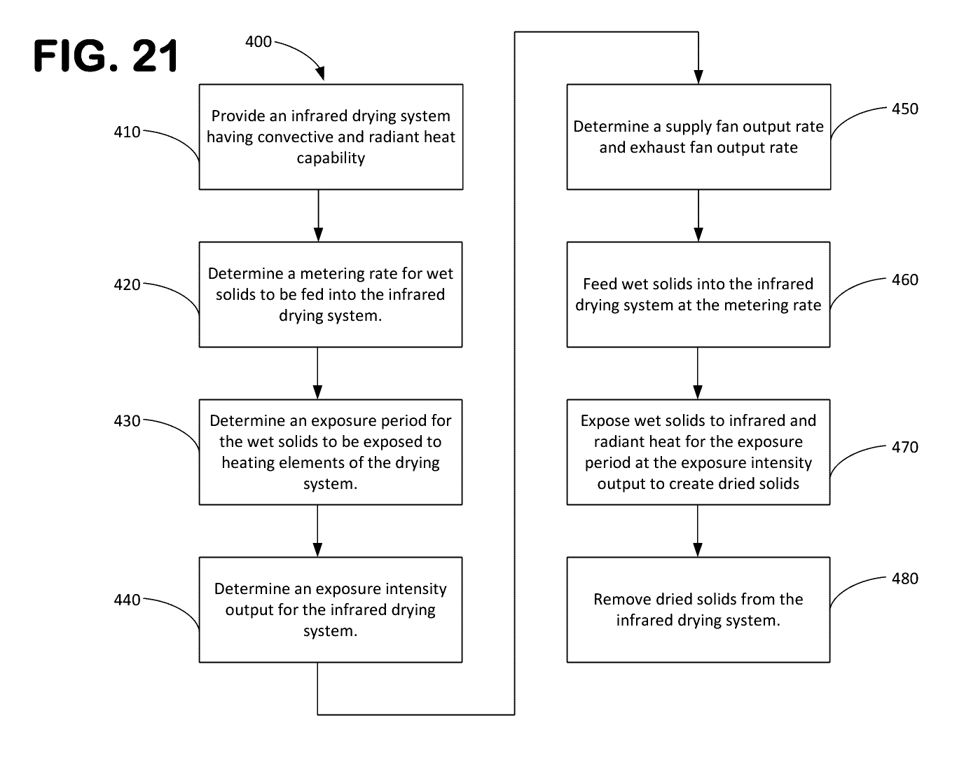

A method 400, shown at FIG. 21, of drying wet organic solids or products utilizing an infrared drying system in accordance with the above described embodiments is also disclosed. By way of non-limiting examples, “wet organic solids” includes any organic solid or semi-solid material comprising at least 10 percent moisture by weight. Examples of wet organic solids are animal parts, plant matter, process waste, and biosolids. In one embodiment, the wet organic solids are Class B biosolids from a waste treatment facility. Class B biosolids contain a geometric mean fecal coliform density of less than 2×10⁶ MPN/g TS (most probable number per gram of total solids on a dry weight basis). Such wet organic solids typically have a moisture content of about 80 percent by weight. In another embodiment, the wet organic solids are derived from a plant, such as algae, vegetable matter, hops, or dried distillers grains from an ethanol production facility. In another embodiment, the wet organic solids are animal parts, such as bird feathers. One skilled in the art will appreciate that virtually any type of wet organic solid may be dried utilizing the disclosed methods and system.

In one step of the process, an infrared drying system is provided. In one embodiment, the infrared drying system has convective and radiant heat capability. In one embodiment, the infrared drying system has a housing; a conveyor extending through the housing; at least one infrared heater located within the housing and being directed towards the conveyor; and a fan for moving an airflow stream through the at least one infrared heater and onto the conveyor. In one embodiment, the drying system includes the above described features for drying system 100 and/or 100′. In one embodiment, the drying system includes a plurality of units arranged end-to-end.

In another step of the process, a metering rate of the wet organic solids can be determined. The metering rate is the rate at which the wet organic solids will be provided to the infrared drying system. In one embodiment, the metering rate is dependent upon the output rate of process equipment upstream of the infrared drying system. In one embodiment, the metering rate is dependent upon the desired output rate of the infrared drying system.

The process may also include a step of determining an exposure period for the wet organic solids. The exposure period is the amount of time the wet organic solids will be exposed to the infrared heater located within the housing. The exposure period is dependent upon the length of the infrared drying system housing; the number, physical size, and orientation of the infrared heaters within the housing; and the speed of the conveyor belt extending through the housing. In one embodiment, the exposure period is dependent upon regulations for time and temperature that a wet solid must be exposed to heat, for example EPA time-temperature regime requirements for human waste treatment. As such, determining the exposure period may comprise or consist of the step of determining the conveyor belt speed. In one example, the dryer 100, 100′, 200 is configured to ensure that wet solids are maintained at 50 degrees Celsius for a period of 30 minutes. One skilled in the art, based on the concepts herein, will appreciate that dryers 100, 100′, and 200 can be configured to meet a wide variety of EPA time-temperature regimes and pathogen reduction protocols.

In another step of the process, an exposure intensity output for the infrared drying system can be determined. The exposure intensity output of the infrared drying system is the level of heat output that will be provided by the infrared heaters within the infrared drying system. Depending upon the type of solids and the moisture content of the product, various output levels of the heaters can be determined to achieve the desired moisture removal from the solids to be dried. Additionally, the exposure intensity output can be dependent upon preventing a condition in which the wet organic solids may be burned or scorched, such as for dried distillers grains.

The disclosed process can also include the steps of determining a supply fan output rate and an exhaust fan output rate necessary to prevent the build-up of a vapor barrier and to remove moisture extracted from the wet organic solids. Alternatively, the supply and exhaust fans can be configured for constant volume operation.

Once the process variables for the operation of the drying system have been determined, the drying of the wet organic solids can be commenced. It is noted that the process can fix certain process variables such that they do not need to be determined and alter remaining process variables to achieve the desired result. In this way, it is not necessary to make a determination of every single operational variable prior to feeding the wet organic solids into the drying system. Furthermore, the process variables may be calculated and/or empirically established to achieve a desired level of moisture removal and/or treatment (e.g. pathogen removal) from the wet organic solids. In this way, such determinations are inherently accomplished by operating the system to achieve a desired result. Where an automation system is used, the process variables can be automatically determined by the controller based on inputs to the controller, such as desired temperature of the solids to be dried, desired internal temperature within the housing, and/or the desired moisture content of the solids to be dried which may be either manually determined or determined by sensors providing feedback to the controller. As such, the steps of determining the exposure intensity and exposure period may be automatically performed by the infrared drying system control system based on various user and/or sensor inputs (e.g. solids type, desired temperature for a specified duration, starting and ending moisture content, solids metering rate, etc.).

Once the drying system is activated, the wet organic solids can be fed into the infrared drying system at the metering rate. The conveyor of the infrared drying system can then transport the wet organic solids into the housing where they will be exposed to both convective and radiant heat through the use of the infrared heaters and supply/exhaust fan(s) for the specified exposure period and intensity output to create dried solids. By use of the term “dried solids,” it is meant to include solids having a moisture content less than the moisture content of the wet organic solids provided to the infrared drying system.

In one example of utilizing the above described process and an infrared drying system in accordance with the concepts of this disclosure, biosolids containing about 78.28 percent by weight water and having a containing fecal coliform density of about 400,000 MPN/g TS were treated. The infrared drying system tested was most similar to that described and shown as infrared drying system 230. The metering rate into the infrared drying system was selected at 700 pounds per hour with a conveyor belt speed of about 663 inches/hour. The exposure output intensity was set to 40,000 watts for the upper infrared heating system and to 40,000 watts for the lower infrared heating system. The resulting exposure period was set to about seven. The supply fan was set to approximately 2,000 cubic feet per minute. The resulting dry solids after treatment by the infrared drying system were measured to have a moisture content of 0.3 percent by weight water and a fecal coliform density at less than 200 MPN/g TS. The dried solids produced, which qualify as Class A biosolids (fecal coliform density below 1,000 MPN/g TS) can be used as biomass fuel or as fertilizer. One will appreciate that the time required and power utilized for processing wet organic solids in accordance with the concepts presented herein are significantly less than that of systems relying solely on convective heating.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

We claim:

1. A process for drying wet organic solids comprising the steps of:
a. providing an infrared drying system having:
i. a housing;
ii. a conveyor extending through the housing;
iii. at least one infrared heater located within the housing and being directed towards the conveyor; and
iv. a fan for moving an airflow stream through the at least one infrared heater and onto the conveyor;
b. providing wet organic solids;
c. feeding the wet organic solids onto the conveyor at a metering rate, the wet organic solids having a moisture content of about 80 percent by weight or less;
d. transporting the wet organic solids into the housing of the drying system;
e. removing moisture from the wet organic solids by exposing the wet organic solids to:
i. at least one infrared heating element within the drying system;
ii. an airflow stream that has been heated by the at least one infrared heating element;
f. allowing the wet organic solids to reach a moisture content of less than 10 percent by weight to result in dried solids; and
g. transporting the dried organic solids out of the housing of the drying system.

2. The process of claim 1, wherein the step of providing wet organic solids includes providing solids derived from plant matter.

3. The process of claim 2, wherein the step of providing wet organic solids includes providing algae.

4. The process of claim 2, wherein the step of providing wet organic solids includes providing hops.

5. The process of claim 2, wherein the step of providing wet organic solids includes providing dried distillers grains.

6. The process of claim 1, wherein the step of providing wet organic solids includes providing animal parts.

7. The process of claim 6, wherein the step of providing wet organic solids includes providing bird feathers.

8. The process of claim 1, wherein the step of providing wet organic solids includes providing solids from a wastewater treatment system.

9. The process of claim 8, wherein the step of providing wet organic solids includes providing Class B biosolids.

10. A process for treating wet organic solids from a wastewater stream comprising the steps of:
a. providing an infrared drying system, the infrared drying system comprising:
i. at least one infrared heating element;
ii. a heated airflow stream;
b. providing wet organic solids having a moisture content of about 80 percent by weight and a fecal coliform density of between about 1,000 MPN/g TS and about 2×10⁶ MPN/g TS;
c. determining a metering rate for feeding the wet organic solids into the treatment system;
d. determining an exposure intensity output for the waste matter treatment system;
e. determining an exposure period for simultaneously exposing the wet organic solids to the heating element and the airflow stream of the treatment system;
f. feeding the wet organic solids at the metering rate into the waste treatment system; and
g. exposing the wet organic solids within the waste treatment system to the at least one infrared heating element and the heated airflow stream for the exposure period at the exposure intensity output;
h. the metering rate, the exposure intensity output, and the exposure period being sufficient to reduce the moisture content of the solids to less than 10 percent by weight, and to reduce the fecal coliform density of the solids to less than 1,000 MPN/g TS to result in dried solids.

11. The process of claim 10, wherein the fecal coliform density of the dried solids is less than 200 MPN/g TS.

12. The process of claim 11, wherein the moisture content of the dried solids is less than 1 percent by weight.

13. An infrared drying system comprising:
a. a rotatable drum having a first end, a second end, and an interior volume, the first end being configured to receive solids, the second end being configured to discharge the solids;
b. a first support structure for supporting the rotatable drum;
c. at least one spiral flight within the interior volume of the drum extending between the first end and the second end of the drum, the spiral flight being attached to an interior side of the drum, the spiral flight being configured to convey solids from the first end to the second end when the drum is rotated;
d. at least one infrared heater within the interior volume of the drum, the infrared heater being configured to direct infrared heat at solids present within the drum; and
e. an exhaust system configured to remove air from the interior volume of the rotatable drum.

14. The infrared drying system of claim 13, further comprising an air knife having a first length and disposed within the interior volume of the rotatable drum, the air knife being configured to discharge air along the first length and towards the solids within the drum.

15. The infrared drying system of claim 14, wherein the air knife has a longitudinal axis that is parallel to a longitudinal axis of the drum and wherein the first length of the air knife is a majority of the distance between the first and second ends of the drum.

16. The infrared drying system of claim 13, wherein the drum further comprises a plurality of cleats extending from the interior side of the drum, the cleats being configured to lift solids from the bottom of the drum when the drum is being rotated.

17. The infrared drying system of claim 13, wherein the at least one spiral flight includes two parallel spiral flights.

18. The infrared drying system of claim 13, wherein the at least one spiral flight has a constant pitch length.

19. The infrared drying system of claim 13, wherein the at least one spiral flight has a variable pitch length, the variable pitch length decreasing towards the second end of the drum.

20. The infrared drying system of claim 13, wherein the at least one infrared heater is slidably mounted within the drum such that the infrared heater can be installed and removed from the drum by sliding the heater along a second support structure.

21. The infrared drying system of claim 13, wherein the second support structure is supported by the first support structure.

22. The infrared drying system of claim 13, wherein the exhaust system is configured to draw air from the second end towards the first end of the drum.

23. The infrared drying system of claim 13, further comprising an inlet hopper and conveyor for transporting the solids into the drum.

24. The infrared drying system of claim 13, wherein the inlet hopper is provided with a vibration mechanism and a sifting screen.

25. The infrared drying system of claim 13, wherein the at least one heater is oriented at an angle with respect to a vertical plane parallel to the longitudinal axis of the drum and extending through the top and bottom of the drum.

26. The infrared drying system of claim 25, wherein the angle is from about 0 degrees to about 90 degrees.

27. The infrared drying system of claim 26, wherein the angle is about 55 degrees.

28. The infrared drying system of claim 25, wherein the drum has a first half and a second half defined by a vertical plane extending along the longitudinal axis of the drum, wherein the drum has a first direction of rotation such that at least a portion of the interior surface of the drum on the first side is moving in an upward direction during rotation, and wherein the at least one infrared heater is oriented within the first side of the drum.

29. The infrared drying system of claim 28, further comprising an air knife having a first length and disposed within the first half of the interior volume of the rotatable drum, the air knife being configured to discharge air along the first length and towards the solids within the drum.

30. The infrared drying system of claim 29, wherein the air knife is disposed below the at least one infrared heater.

31. The infrared drying system of claim 19, wherein the at least one flight has a height that decreases from the first end of the drum towards the second end of the drum.

32. The infrared drying system of claim 31, wherein the drum and the at least one flight define a first volume near the first end of the drum and a second volume near the second end of the drum, and wherein the second volume is less than the first volume.

33. The infrared drying system of claim 32, wherein the second volume is about one seventh the volume of the first volume.

34. The infrared drying system of claim 32, wherein the ratio of the second volume to the first volume is a function of the expected volume reduction of the solids during drying.
